(19) United States
(12) Patent Application Publication
(10) Pub. No.: US 2024/0269493 A1
(43) Pub. Date: Aug. 15, 2024

(54) NECK COLLAR CAPABLE OF SUPPLYING OXYGEN TO COMPANION ANIMAL AND SYSTEM FOR OXYGEN SUPPLY THROUGH NECK COLLAR TO COMPANION ANIMAL

(71) Applicants: Hee Jin HWANG, Seoul (KR); Chang Young IM, Seoul (KR)

(72) Inventors: Hee Jin HWANG, Seoul (KR); Chang Young IM, Seoul (KR)

(21) Appl. No.: 18/557,781

(22) PCT Filed: Jul. 15, 2021
(86) PCT No.: PCT/KR2021/009096

§ 371 Date: Mar. 29, 2024

(30) Foreign Application Priority Data
Apr. 29, 2021 (KR) 10-2021-0055604
Apr. 29, 2021 (KR) 10-2021-0055605

(51) Int. Cl. A62B 18/06; A62B 18/00; A62B 18/10; A62B 23/02

(52) U.S. Cl. CPC A62B 18/06; A62B 18/003; A62B 18/10; A62B 23/02

(57) ABSTRACT

A neck collar capable of supplying oxygen to a companion animal, includes: a neck mounting part, an oxygen cap, and a respiratory tube, or may comprise a neck mounting part, an oxygen cap, and a filter part. In addition, a system for oxygen supply through a neck collar may comprise a neck mounting part, an oxygen cap, a respiratory tube, and a filter part, and additionally comprise a user terminal, a respiratory sensor unit, a control unit, and a communication unit, so as to analyze respiratory pattern information and generate locking information on a respiratory tube valve.

### CROSS-REFERENCE TO PRIOR APPLICATIONS

This application is a National Stage patent application of PCT International Application No. PCT/KR2021/009096 (filed on Jul. 15, 2021), which claims priority to Korean Patent Application Nos. 10-2021-0055604 (filed on Apr. 29, 2021) and 10-2021-0055605 (filed on Apr. 29, 2021), which are all hereby incorporated by reference in their entirety.

### BACKGROUND

The present disclosure relates to a neck collar for companion animals capable of supplying oxygen and an oxygen supply system through a neck collar for companion animals, and more particularly, to a neck collar for companion animals capable of supplying oxygen and an oxygen supply system through a neck collar for companion animals which is capable of comfortably supplying oxygen to companion animals without location restrictions and equipped with a filter allowing the companion animals to respire healthily.

Recently, as the culture of considering companion animals as family members has spread, the number of domestic companion animals has exceeded 10 million, and the number of people raising companion animals has reportedly exceeded 15 million. Since companion animals such as dogs and cats have shorter lifespans than humans, the domestic companion animal medical market is also rapidly increasing.

Unlike doctors who can communicate with humans, veterinarians cannot directly communicate with companion animals, so it is relatively difficult to equip companion animals with medical devices.

In particular, when trying to attach an oxygen mask to the mouth of the companion animal to supply oxygen to the companion animal whose health has deteriorated, there is a risk of nurses or veterinarians being bitten by the companion animal, and there is a problem that the companion animal is also stressed.

In addition, due to the increased number of people raising companion animals, the number of people who enjoy walking with their companion animals at nearby parks has also increased, and recently, as the frequency of fine dust or yellow dust has increased on the Korean Peninsula, the risk of companion animals developing respiratory diseases when taking a walk is also increasing. In particular, due to the recent coronavirus outbreak, like humans, companion animals need to wear masks when going out.

In order to solve this problem, conventionally, masks for companion animals have been developed for companion animals (Korean Patent No. 10-1975716). However, the conventional mask has difficult configuration for the guardian of the companion animal to put on the companion animal, and there is a problem in that the companion animal wearing the conventional mask also feels uncomfortable.

### SUMMARY

An object of embodiments of the present disclosure is to provide a neck collar and a system that provide oxygen to the head of a companion animal based on respiration of the companion animal and at the same time protect the head of the companion animal.

In addition, an object of the present disclosure is to provide a simple means to protect the companion animal from polluted air or viruses.

In addition, an object of the present disclosure is to make it easy for the companion animal to wear it, and to prevent the companion animal from biting other people when the companion animal wears it.

Problems to be solved by the present disclosure are not limited to the problems mentioned above, and other problems not mentioned can be clearly understood by those skilled in the art from the description below.

A neck collar for companion animals capable of supplying oxygen according to an embodiment to solve the above-mentioned problems includes: a neck mounting part provided with a through hole in which a neck of a companion animal is positioned when worn by the companion animal; an oxygen cap coupled to the neck mounting part and forming a predetermined space to accommodate a head of the companion animal; and a respiratory tube with one end passing through one side surface of the oxygen cap and connected to the oxygen cap, so as to supply oxygen inside the oxygen cap.

In addition, the respiratory tube includes a respiratory tube valve located at one end of the respiratory tube to be coupled to the respiratory tube, so as to control an amount of oxygen supplied to the oxygen cap.

In addition, the oxygen cap includes a respiratory tube with one end passing through one side surface of the oxygen cap and connected to the oxygen cap, so as to supply oxygen inside the oxygen cap.

In addition, the neck mounting part includes an air tube capable of being compressed and expanded by inflow and outflow of air; and an air supply tube connected to allow communication between the air tube and an outside, so as to allow air to flow into and out of the air tube.

In addition, the air tube includes an elastic body configured to be stored in a compressed state inside the air tube and expand when the air supply tube is opened so that air automatically flows into the air tube.

In addition, the air tube includes a first air tube and a second air tube configured to be separated and coupled based on a plane of symmetry, and the air supply tube includes a first air supply tube located on the first air tube and configured to allow communication of air between the first air tube and the outside, and a second air supply tube located on the second air tube and configured to allow communication of air between the second air tube and the outside.

In addition, the neck mounting part is formed so that a side surface is bent, to allow the companion animal to lean its head when sitting or lying down.

In addition, the through hole includes an elastic member formed surrounding an inner surface of the through hole, so as be coupled to the neck of the companion animal by being stretched to fit a neck circumference of the companion animal; and a locking part configured to lock-couple the elastic member to fit a neck size of the companion animal.

In addition, the oxygen cap may be configured so that a lower side of the oxygen cap is zipper-coupled with an outer side surface of the neck mounting part.

A neck collar for companion animals capable of supplying oxygen according to another embodiment to solve the above-mentioned problems includes: a neck mounting part provided with a through hole in which a neck of a companion animal is positioned when worn by the companion animal; an oxygen cap coupled to the neck mounting part and forming a predetermined space to accommodate a head of the companion animal; and a filter part whose upper side is coupled to the oxygen cap and whose lower side is coupled to the neck mounting part.

In addition, the neck collar includes a respiratory tube with one end passing through one side surface of the oxygen cap and connected to the oxygen cap, so as to supply oxygen inside the oxygen cap.

In addition, the respiratory tube includes a respiratory tube valve located at one end of the respiratory tube to be coupled to the respiratory tube, so as to control an amount of oxygen supplied to the oxygen cap.

In addition, the upper side of the filter part may be zipper-coupled with a lower side of the oxygen cap and the lower side of the filter part may be zipper-coupled with an upper side of the neck mounting part, so that the filter part is capable of being separated and coupled.

In addition, the filter part includes a bellows filter capable of contracting and expanding along a height direction.

In addition, the neck mounting part includes an air tube capable of being compressed and expanded by inflow and outflow of air; and an air supply tube connected to allow communication between the air tube and an outside, so as to allow air to flow into and out of the air tube.

In addition, the air tube includes an elastic body configured to be stored in a compressed state inside the air tube and expand when the air supply tube is opened so that air automatically flows into the air tube.

In addition, an oxygen supply system through a neck collar for companion animals according to an embodiment to solve the above-mentioned problems may include: a neck mounting part provided with a through hole in which a neck of a companion animal is positioned when worn by the companion animal; an oxygen cap coupled to the neck mounting part and forming a predetermined space to accommodate a head of the companion animal; a respiratory tube with one end passing through one side surface of the oxygen cap and connected to the oxygen cap, so as to supply oxygen inside the oxygen cap; a filter part whose upper side is coupled to the oxygen cap and whose lower side is coupled to the neck mounting part; a user terminal capable of communication; a respiratory sensor unit configured to detect information on respiration of the companion animal accommodated in the oxygen cap; a controller configured to receive and analyze information of the respiratory sensor unit; and a communication unit connected to the user terminal, the respiratory sensor unit, and the controller to be able to conduct electricity, wherein the controller is configured to receive concentration information of carbon dioxide emitted through the respiration of the companion animal and present inside the oxygen cap from the respiratory sensor unit, analyze respiratory pattern information of the companion animal through the carbon dioxide concentration information, and generate closing information of the respiratory tube valve based on the carbon dioxide concentration information and the respiratory pattern information.

According to an embodiment of the present disclosure, the respiratory tube supplies oxygen to the oxygen cap to increase oxygen concentration inside the oxygen cap, so that the respiration of the companion animal may become more smooth.

In addition, the oxygen cap coupled with the neck mounting part forms a space to accommodate the head of the companion animal, thereby preventing foreign substances from entering the eyes or ears of the companion animal.

In addition, the present disclosure allows air to flow in and out of the air tube included in the neck mounting part, so the companion animal may sit or lie down with its head against the air tube, allowing the companion animal to rest in a comfortable position.

In addition, the present disclosure may protect the health of the companion animal from polluted atmosphere by providing a filter part coupled with the oxygen cap and the neck mounting part.

In addition, the present disclosure when worn by a companion animal, since the neck of the companion animal is located in the through hole of the neck mounting part making it easier for the companion animal to wear compared to the case of wearing it in the mouth, may prevent the companion animal from easily taking it off on its own.

In addition, the present disclosure when worn by a companion animal may prevent the companion animal from biting a person, because the oxygen cap forms a space that may accommodate the head of the companion animal, and the mouth of the companion animal is located inside the oxygen cap and is distinguished from the outside of the oxygen cap.

Effects of the present disclosure are not limited to the effects mentioned above, and other effects not mentioned will be clearly understood by those skilled in the art from the description below.

### BRIEF DESCRIPTION OF THE DRAWINGS

FIG. 1 is a perspective view illustrating an appearance of an embodiment of a neck collar for companion animals capable of supplying oxygen according to the present disclosure.

FIG. 2 is a diagram illustrating an embodiment in which a neck collar for companion animals of FIG. 1 further includes a filter part.

FIG. 3 is a perspective view illustrating an appearance of another embodiment of a neck collar for companion animals capable of supplying oxygen according to the present disclosure.

FIG. 4A is a schematic diagram illustrating an operation of a Velcro member according to another embodiment of the present disclosure.

FIG. 4B is a schematic diagram illustrating another operation of a Velcro member of FIG. 4A.

FIG. 5 is a cross-sectional view illustrating a portion of FIG. 2.

FIG. 6A is a schematic diagram illustrating another embodiment of the filter part of FIG. 5.

FIG. 6B is a schematic diagram illustrating another operation of FIG. 6A.

FIG. 7A is a diagram illustrating an air tube of a neck mounting part of a neck collar for companion animals capable of supplying oxygen according to the present disclosure.

FIG. 7B is a schematic diagram illustrating another operation of FIG. 7A.

FIG. 8A is a diagram illustrating a respiratory tube of a neck collar for companion animals capable of supplying oxygen according to the present disclosure.

FIG. 8B is a diagram illustrating another operation of the respiratory tube of FIG. 8A.

FIG. 9 is a perspective view illustrating another embodiment of FIG. 2.

FIG. 10 is a diagram illustrating a state in which a companion animal is wearing a neck collar for companion animals capable of supplying oxygen according to the present disclosure.

FIG. 11 is a block diagram of a companion animal breathing detection system according to the present invention.

### DETAILED DESCRIPTION

Advantages and features of the present disclosure and methods for achieving them will become clear by referring to the embodiments described in detail below along with the accompanying drawings. However, the present disclosure is not limited to the embodiments disclosed below and may be implemented in various different forms, and the present embodiments are merely provided to make the present disclosure complete and to fully inform those skilled in the art to which the present disclosure pertains of the scope of the present disclosure, and the present disclosure is only defined by the scope of the claims.

Terms used herein are intended to describe embodiments and are not intended to limit the present disclosure. As used herein, singular forms also include plural forms, unless specifically stated otherwise in the context. As used herein, “comprises” and/or “comprising” do not exclude the presence or addition of one or more other components in addition to the mentioned components. Throughout the specification, like reference numerals refer to like components, and “and/or” includes each and every combination of one or more of the referenced components. Although “first”, “second”, etc., are used to describe various components, these components are not limited by these terms. These terms are merely used to distinguish one component from another component. Therefore, a first component mentioned below may also be a second component within the technical idea of the present disclosure.

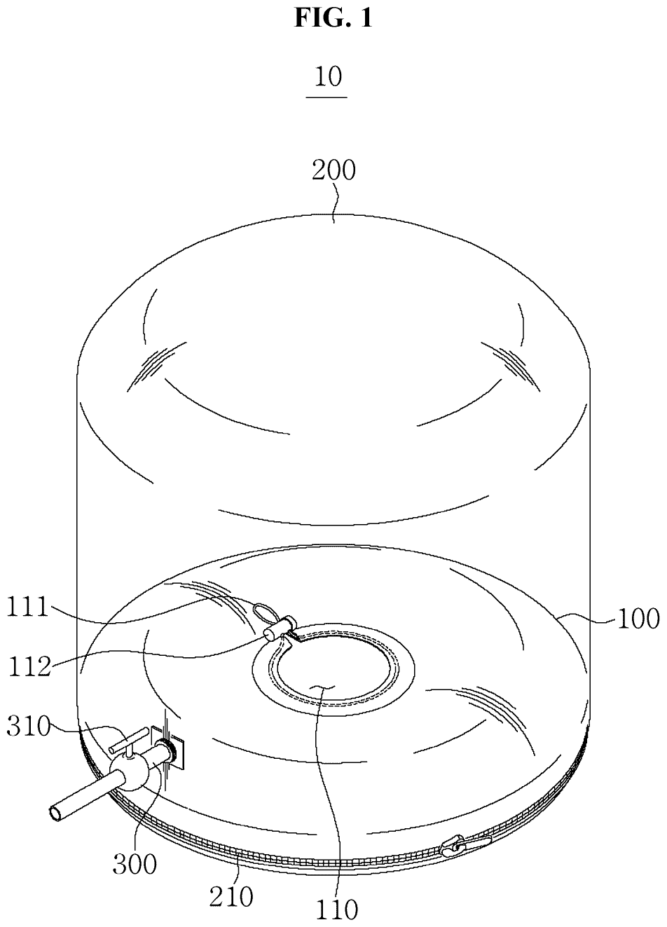

The terms “front side”, “rear side”, “left side”, “right side”, “upper side” and “lower side” used in the following description will be understood with reference to the coordinate system shown in FIG. 1.

The term “horizontal direction” as used in the following description means the front side, rear side, left side or right side direction with the upper side or lower side position unchanged, and the term “vertical direction” as used in the following description means the upper side or lower side direction with the front side, rear side, left side or right side direction position unchanged.

Unless otherwise defined, all terms (including technical and scientific terms) used herein may be used with meanings commonly understood by those skilled in the art to which the present disclosure pertains. In addition, terms defined in commonly used dictionaries are not interpreted ideally or excessively unless clearly specifically defined.

Hereinafter, embodiments of the present disclosure will be described in detail with reference to the accompanying drawings.

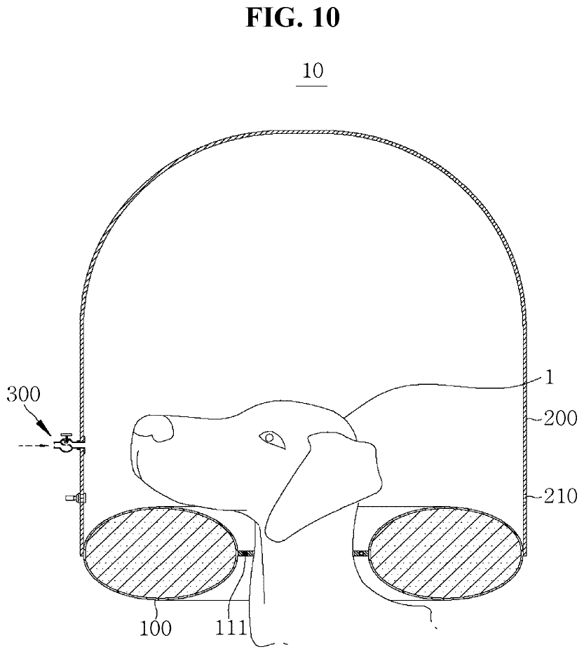

FIG. 1 is a perspective view illustrating an appearance of an embodiment of a neck collar 10 for companion animals capable of supplying oxygen according to the present disclosure, and FIG. 10 is a diagram illustrating a state in which a companion animal is wearing the neck collar 10 for companion animals capable of supplying oxygen according to the present disclosure.

Referring to FIGS. 1 and 10, the neck collar 10 for companion animals capable of supplying oxygen includes a neck mounting part 100, an oxygen cap 200, and a respiratory tube 300. In some embodiments, the neck collar capable of supplying oxygen may be configured to include more or fewer components than those shown in FIG. 1.

The neck mounting part 100 is configured to position the neck of the companion animal 1 when worn by the companion animal 1, and includes a through hole 110.

The neck mounting part 100 may be formed of a material that generates elasticity for comfortable wearing of the companion animal 1, such as a general cushion and a tube that allows the inflow of air, but is not limited thereto.

In addition, the neck mounting part 100 is formed of an antibacterial material or a natural material, so as to prevent skin disease in the companion animal 1.

The shape of the neck mounting part 100 has a donut shape in its horizontal cross section, i.e., a cross section perpendicular to the height direction, but its shape may be changed to a polygon.

Although not shown, the neck mounting part 100 may be formed in various shapes to correspond to the type of companion animal 1 and the weight of each companion animal 1.

When the companion animal 1 wears the present disclosure, the neck of the companion animal 1 is located in the through hole 110. The through hole 110 includes a fastening part such as a string, rubber band, tape, adhesive, etc., to waterproof or seal the oxygen cap 200, which will be described later. Preferably, the fastening part may be formed of any one of rubber, silicone, Velcro, string synthetic resin, and a band.

The through hole 110 includes an elastic member 111 and a locking part 112.

The elastic member 111 is preferably formed of an elastic body to be stretched to fit a neck circumference of the companion animal 1 for sealing. When the companion animal 1 wears the present disclosure, the elastic member 111 is formed by surrounding the inner surface of the through hole 110 so as to be coupled to the neck of the companion animal 1.

The locking part 112 is configured to enable lock-coupling of the elastic member 111 to fit a neck size of the companion animal 1. The locking portion 112 may be the same stopper as a typical rubber band stopper for fixing the elastic member 111. Therefore, detailed description of the stopper will be omitted.

The oxygen cap 200 is coupled with the neck mounting part 100 and forms a predetermined space in which the head of the companion animal 1 is accommodated. The oxygen cap 200 is preferably formed of a transparent material to ensure visibility of the companion animal 1.

The oxygen cap 200 coupled with the neck mounting part 100 may prevent foreign substances from entering the eyes or ears of the companion animal 1.

In addition, the oxygen cap 200 may be formed of a waterproof material.

Although not shown, the oxygen cap 200 may be provided with a small hole on the upper side surface to allow the inflow and outflow of a small amount of air to prevent the inside of the oxygen cap 200 from becoming humid and blocking the view of the companion animal 1.

The lower side of the oxygen cap 200 may be zipper-coupled with the outer side surface of the neck mounting part 100. To this end, the oxygen cap 200 and the neck mounting part 100 are provided with zipper members 210 at corresponding positions where they are coupled to each other. At this time, the zipper member 210 does not have to surround the entire side surface of the oxygen cap 200, and may be formed only on a portion of the side surface.

The zipper member 210 provided for coupling the oxygen cap 200 and the neck mounting part 100 is the same as a typical zipper for coupling, so a detailed description thereof will be omitted.

The oxygen cap 200 zipper-coupled to the neck mounting part 100 is detachable from the neck mounting part 100. Due to this, in the present disclosure, the oxygen cap 200 may be separated and washed, and the oxygen cap 200 may also be easily replaced, helping to improve the hygiene of the companion animal 1.

The respiratory tube 300 is provided to supply oxygen to the inside of the oxygen cap 200. The respiratory tube 300 is connected to the oxygen cap 200 by one end passing through one side surface of the oxygen cap 200.

Meanwhile, according to an embodiment of the present disclosure, the respiratory tube 300 supplies oxygen to the oxygen cap 200 to increase the oxygen concentration inside the oxygen cap 200, so that the respiration of the companion animal 1 may become more smooth.

Although not shown, the other end of the respiratory tube 300 may be connected to an oxygen supply device. The oxygen supply device refers to a typical medical oxygen supply device, small oxygen tank, etc.

Generally, when a sick companion animal 1 is hospitalized at a veterinary hospital, it is put into a rectangular parallelepiped-shaped oxygen supply device, and in this case, many companion dogs express anxiety due to narrow space or separation from their guardians. The companion animal 1 using the present disclosure may receive oxygen supply without such anxiety, and may stay by the guardian without being separated from the guardian.

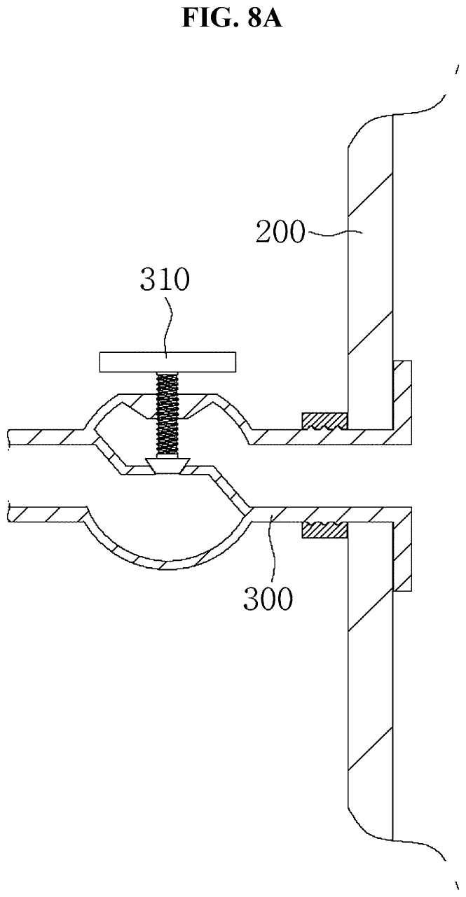

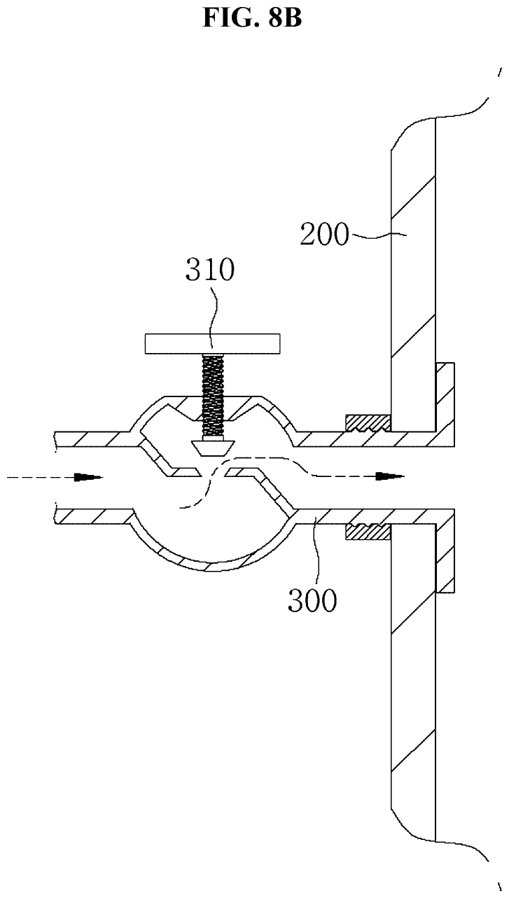

FIG. 8A is a diagram illustrating a respiratory tube 300 of a neck collar 10 for companion animals capable of supplying oxygen according to the present disclosure, FIG. 8B is a diagram illustrating another operation of a respiratory tube 300 of FIG. 8A.

Referring to FIGS. 8A and 8B, the respiratory tube 300 includes a respiratory tube valve 310 located at one end of the respiratory tube 300 and coupled to the respiratory tube 300 so as to control the amount of oxygen supplied to the oxygen cap 200.

Referring to the drawings, when the user closes the respiratory tube valve 310, the amount of air that may pass through the respiratory tube 300 decreases, and when the user opens the respiratory tube valve 310, the amount of air that may pass through the respiratory tube 300 increases.

Whether the oxygen supply inside the oxygen cap 200 is sufficient or insufficient may be determined through the respiratory sensor unit 700, which will be described later. A detailed description of this will be provided later.

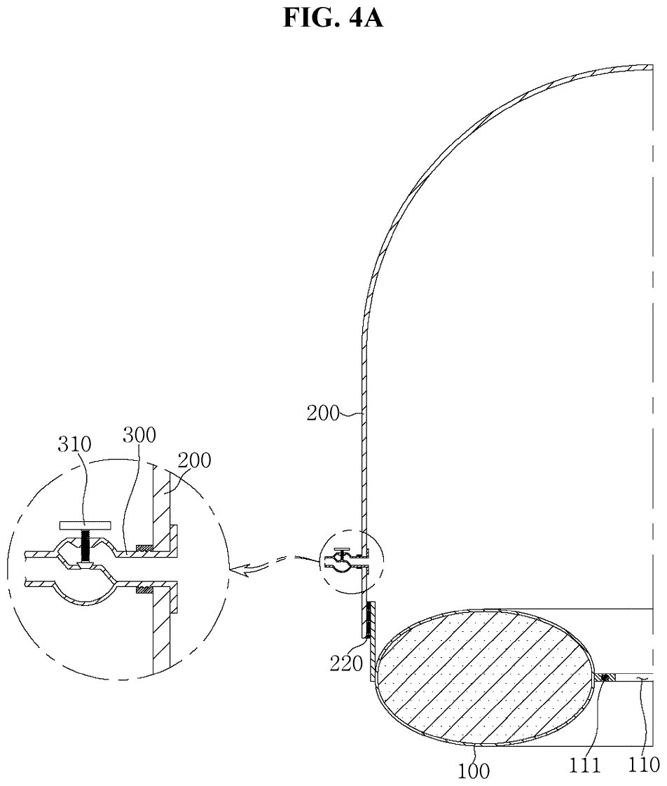

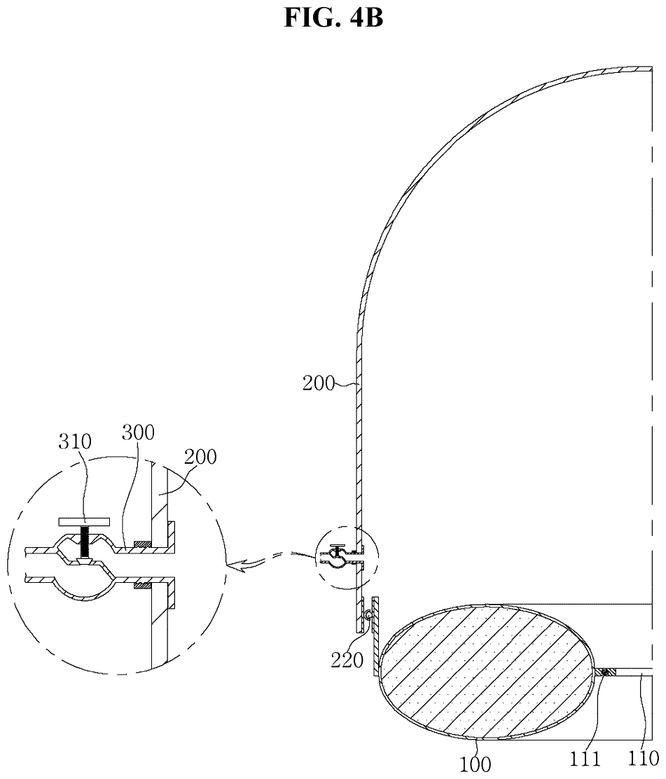

FIG. 4A is a schematic diagram illustrating an operation of a Velcro member 220 according to another embodiment of the present disclosure, FIG. 4B is a schematic diagram illustrating another operation of the Velcro member 220 of FIG. 4A.

Referring to FIGS. 4A and 4B, the Velcro member 220 consists of a male/female pair, and is configured to be connected to the neck mounting part 100 and the oxygen cap 200, respectively. Due to this, the oxygen cap 200 may be simply separated from the neck mounting part 100 and cleaned, and in case the oxygen cap 200 is damaged, replacement of the oxygen cap 200 may also be easily performed, which helps improve the hygiene of the companion animal 1 and maintaining the durability of the present disclosure.

Since the coupling of the pair of the Velcro member 220 is a known invention, a detailed description thereof will be omitted.

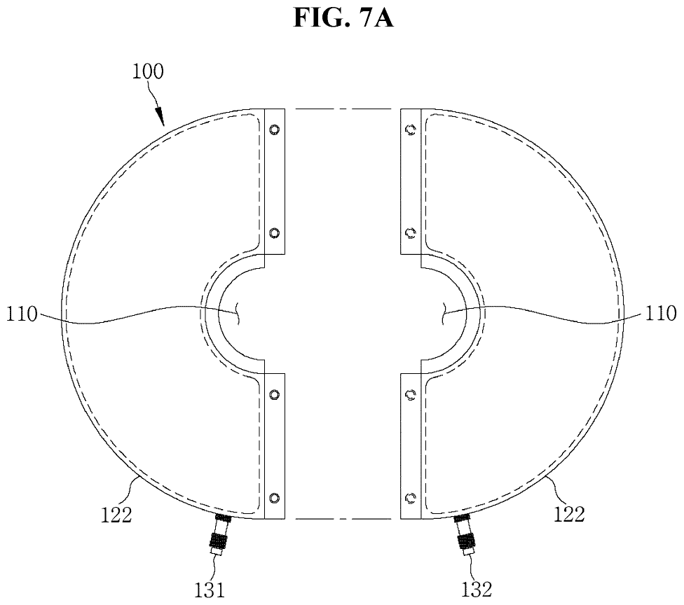

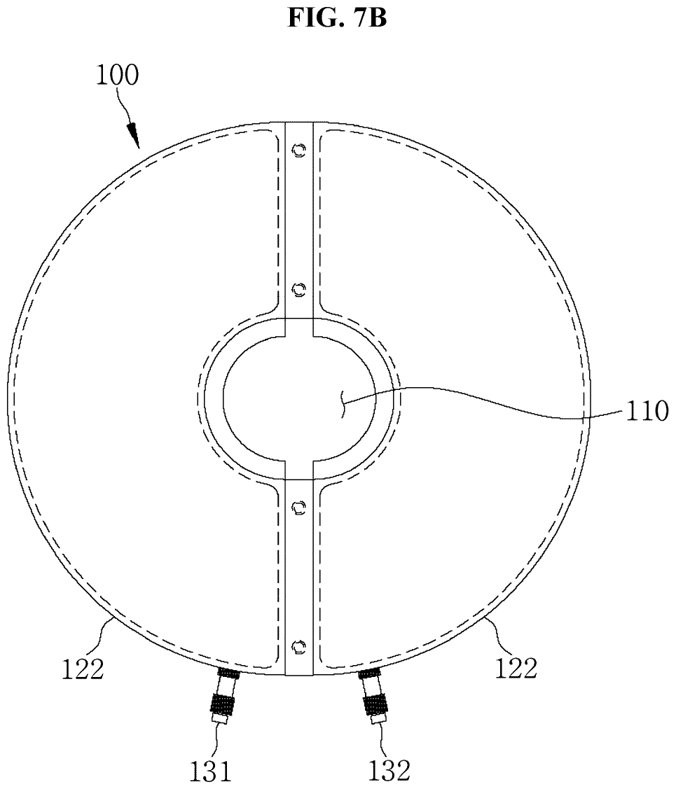

FIG. 7A is a diagram illustrating an air tube 120 of the neck mounting part 100 of the neck collar 10 for companion animals capable of supplying oxygen according to the present disclosure, and FIG. 7B is a schematic diagram illustrating another operation of FIG. 7A.

As described above, the neck mounting part 100 may be formed of a tube allowing air inflow, and referring to FIGS. 7A and 7B, the neck mounting part 100 includes the air tube 120 and an air supply tube 130.

In addition, since the present disclosure allows air to flow in and out of the air tube 120 included in the neck mounting part 100, the companion animal 1 may sit or lie down with its head against the air tube 120, allowing the companion animal 1 to rest in a comfortable position.

The air tube 120 is configured to be compressed and expanded by the inflow and outflow of air.

When the companion animal 1 is not wearing the present disclosure, the volume of the air tube 120 may be reduced without introducing air into the air tube 120, so storage of the present disclosure will be easy.

Meanwhile, the air tube 120 includes a first air tube 121, a second air tube 122, and an elastic body (not shown).

The first air tube 121 and the second air tube 122 are configured to be separated and coupled based on the plane of symmetry. As a result, after separating the first air tube 121 and the second air tube 122, air is introduced into each to expand to the maximum, and in this state, the companion animal 1 may be worn on the neck and at the same time the first air tube 121 and the second air tube 122 may be coupled as shown.

Therefore, it is convenient to use because the user may immediately wear the present disclosure to the companion animal 1 without the need for the through hole 110 of the air tube 120 to pass through the head of the companion animal 1.

The elastic body (not shown) is formed of a highly elastic material, and a general sponge material with a large number of irregular pores may also be used. Due to the restoring force of the elastic body (not shown), external air is sucked into the air tube 120 and filled to atmospheric pressure without an air pump.

Specifically, the elastic body (not shown) is stored in a compressed state inside the air tube 120. The elastic body expands when the air supply tube 130 is opened, and external air flows into the air tube 120. As a result, air automatically flows into the air tube 120 and the air tube 120 automatically expands.

Although not shown, the air tube 120 may be connected to the oxygen cap 200 through a zipper-coupling. At this time, a zipper member for zipper-coupling may be formed on either side surface of the first air tube 121 or the second air tube 122.

Although not shown, the air tube 120 may be connected to the oxygen cap 200 with Velcro. A Velcro member for this may be disposed on the side surfaces of the air tube 120 and the oxygen cap 200.

The air supply tube 130 is connected to the air tube 120 to allow the inflow and outflow of air from the air tube 120.

To prevent excessive air from flowing into the air tube 120 and bursting the air tube 120, a check valve (not shown) may be disposed at one end of the air supply tube 130. When the preset pressure in the air tube 120 is exceeded, a check valve (not shown) is configured to block air from flowing into the air tube 120 through the air supply tube 130.

The air supply tube 130 includes a first air supply tube 131 and a second air supply tube 132.

The first air supply tube 131 is located on the first air tube 121 and is configured to allow air communication between the first air tube 121 and the outside.

The second air supply tube 132 is located on the second air tube 122 and is configured to allow air communication between the second air tube 122 and the outside.

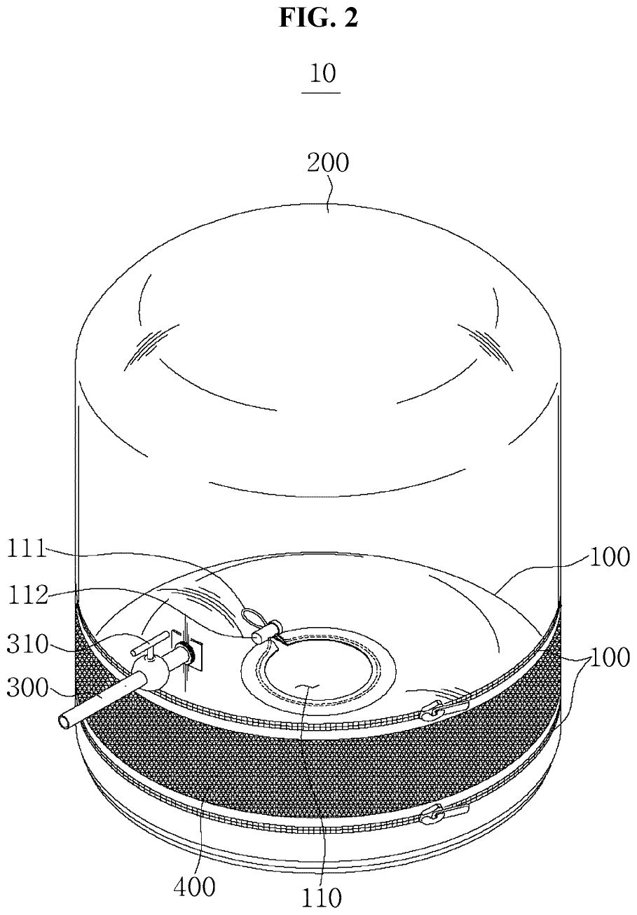

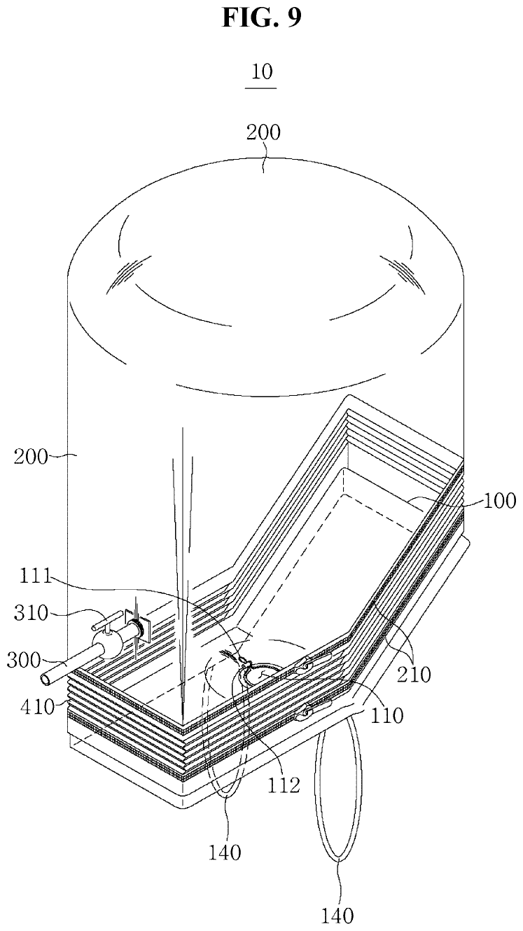

FIG. 9 is a perspective view illustrating another embodiment of FIG. 2.

Referring to FIG. 9, the neck mounting part 100 is formed so that a side surface is bent, to allow the companion animal 1 to lean its head when sitting or lying down.

If the neck mounting part 100 is formed only in the above-described donut shape, when the companion animal 1 sits or lies down while wearing the present disclosure, the front side of the neck mounting part 100 is bent as it touches the floor, and as a result, the neck mounting part 100 may press the area around the neck of the companion animal 1, causing the companion animal 1 to feel uncomfortable.

Therefore, in order to solve such inconvenience, the neck mounting part 100 may be formed with a bent side surface shape as shown.

In addition, when a companion animal moves while wearing the neck collar 10 for companion animals provided with a replaceable filter, the neck mounting part may rotate differently from the initial wearing position depending on the movement of the companion animal 1, and to prevent this, a leg hanger 140 may be provided on the lower surface of the neck mounting part 100 so that the companion animal 1 may hang its legs when worn.

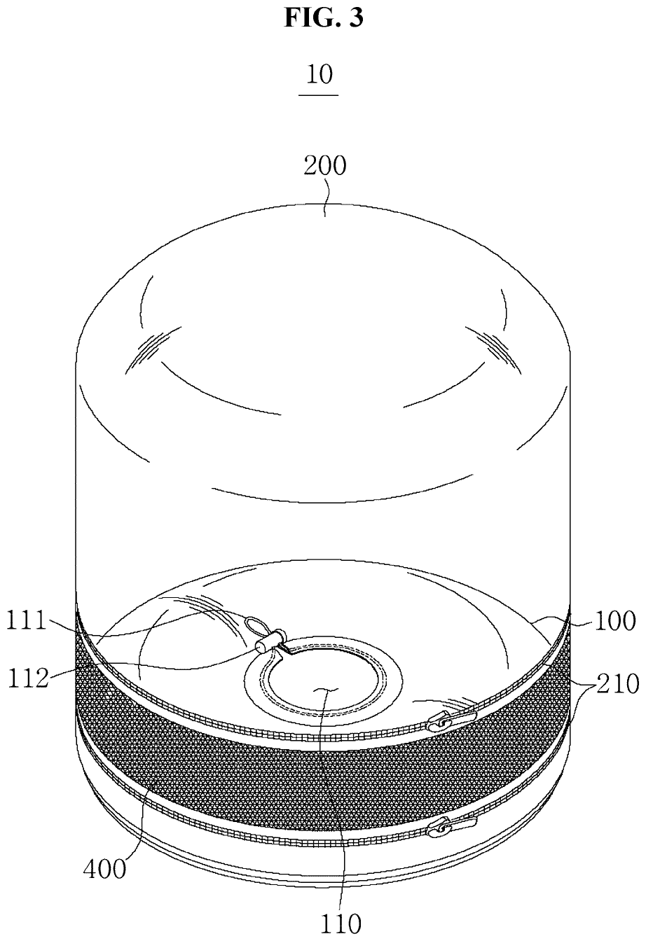

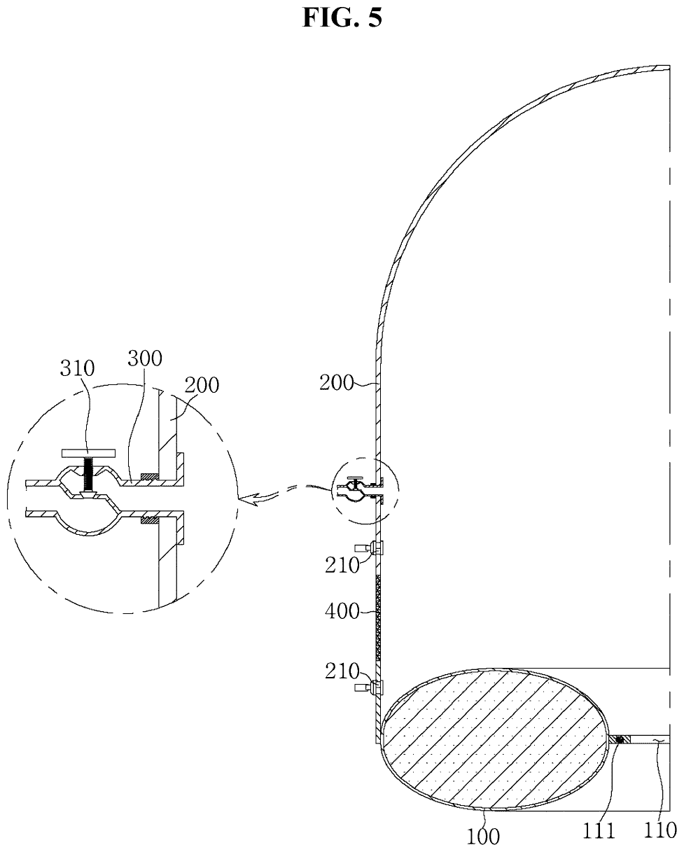

FIG. 2 is a diagram illustrating an embodiment in which a neck collar for companion animals of FIG. 1 further includes a filter part 400, FIG. 3 is a perspective view illustrating an appearance of another embodiment of a neck collar 10 for companion animals capable of supplying oxygen according to the present disclosure, and FIG. 5 is a cross-sectional view illustrating a portion of FIG. 2.

Referring to FIGS. 2, 3 and 5, the oxygen cap 200 coupled with the neck mounting part 100 may prevent foreign substances from entering the eyes or ears of the companion animal 1. However, when the companion animal 1 wears the present disclosure, if the neck of the companion animal 1 comes into close contact with the through hole 110, respiration of the companion animal 1 may be difficult. Therefore, in order to solve this, the filter part 400 to be described later is provided.

The filter part 400 serves to filter out foreign substances in liquid or gas, and is configured such that the upper side is coupled to the oxygen cap 200 and the lower side is coupled to the neck mounting part 100.

The filter part 400 coupled with the oxygen cap 200 and the neck mounting part 100 may protect the health of the companion animal 1 by filtering out fine dust or yellow dust from polluted external air when the companion animal 1 respires while wearing it.

Previously, masks for companion animals were developed, such as Korean Patent No. 10-1975176, to protect companion animals from fine dust or yellow dust, but since it blocks the mouth of the companion animal, there is a problem that it is difficult for the guardian to have the companion animal wear it, and the companion animal wearing it also feels uncomfortable. However, the neck collar 10 for companion animals provided with a replaceable filter has the neck of the companion animal 1 located in the through hole 110 of the neck mounting part 100 as described above, so it may be worn by the companion animal 1 relatively more easily than when worn in the mouth. In addition, it is difficult for companion animals to take off on their own compared to conventional masks for companion animals worn on the mouth.

Meanwhile, the filter part 400, oxygen cap 200, and neck mounting part 100 may be coupled by a zipper, and for this purpose, the filter part 400, oxygen cap 200, and neck mounting part 100 are provided with a zipper member 210. In other words, the upper side of the filter part 400 is configured to be coupled to the lower side of the oxygen cap 200 through the zipper member 210, and the lower side of the filter part 400 is configured to be coupled to the upper side of the neck mounting part 100 through the zipper member 210.

Specifically, the oxygen cap 200, neck mounting part 100, and filter part 400 are provided with zipper members 210 at corresponding positions where they are coupled to each other. At this time, the zipper member 210 does not have to surround the entire side surface of the oxygen cap 200, and may be formed only on a portion of the side surface.

Since the zipper member 210 is the same as a typical zipper for zipper-coupling, detailed description thereof will be omitted.

Meanwhile, since the zipper member 210 is provided, even if the filter part 400 becomes dirty due to frequent use, the filter part 400 may be easily replaced by opening the zipper.

Likewise, even if the oxygen cap 200 becomes dirty, since the oxygen cap 200 and the filter part 400 are zipper-coupled and is detachable, the oxygen cap 200 may be separated and washed or replaced, which is helpful for the hygiene of the companion animal 1.

In addition, when the companion animal 1 wears the neck collar 10 for companion animals provided with a replaceable filter, since the mouth of the companion animal 1 is located inside the oxygen cap 200 and is distinguished from the outside of the oxygen cap 200, the companion animal 1 will be prevented from biting a person even without a muzzle, and at the same time, the companion animal 1 will also experience less discomfort.

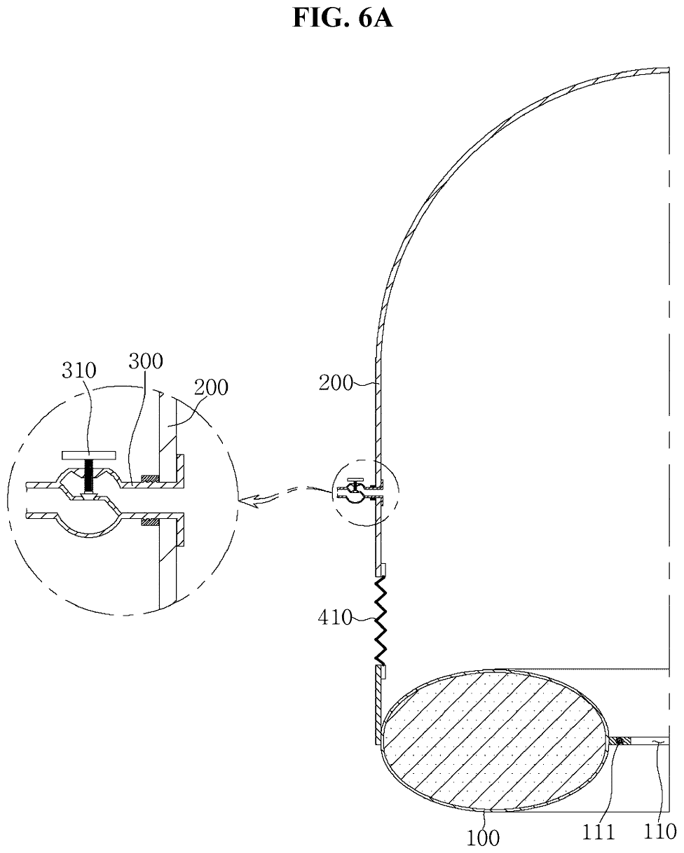

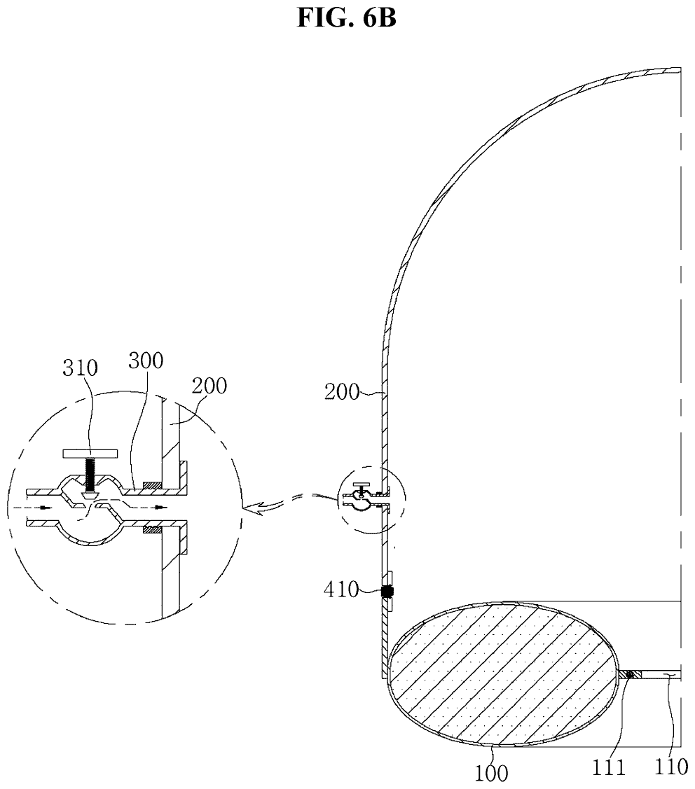

FIG. 6A is a schematic diagram illustrating another embodiment of the filter part 400 of FIG. 5, and FIG. 6B is a schematic diagram illustrating another operation of FIG. 6A.

Referring to FIGS. 6A and 6B, the filter part 400 includes a bellows filter 410.

The bellows filter 410 is a filter configured to expand and contract along the height direction. Specifically, the bellows filter 410 may be provided in a zigzag shape, but its shape is not limited to the zigzag shape.

In an embodiment, the bellows filter 410 may be folded when the filter function is not in use. On the other hand, on days when the concentration of fine dust is high, the folded bellows filter 410 may be unfolded and expanded to the maximum to filter dust entering the oxygen cap 200.

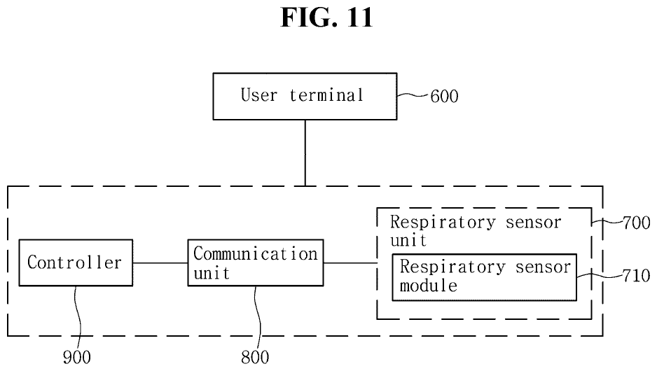

FIG. 11 is a block diagram of a companion animal breathing detection system according to the present invention.

Referring to FIG. 11, the configuration of the user terminal 600, the respiratory sensor unit 700, the communication unit 800, and the controller 900 is shown. Each element constituting the user terminal 600, the respiratory sensor unit 700, the communication unit 800, and the controller 900 are provided in any form capable of inputting, outputting, and calculating information, and may be connected to each other to be able to conduct electricity. In an embodiment, each of the above elements may be provided as a microprocessor, CPU, etc.

The user terminal 600 may receive information on the respiration of the companion animal 1, which will be described later, from the neck collar 10 for companion animals capable of supplying oxygen. In an embodiment, the user terminal 600 may be provided as a smartphone, tablet PC, laptop, etc.

The respiratory sensor unit 700 may be configured to detect information on the respiration of the companion animal 1 accommodated in the oxygen cap 200.

The respiratory sensor unit 700 is not shown, but may be attached to the inner side surface of the oxygen cap 200 or attached to the upper surface of the neck mounting part 100. The location of the respiratory sensor unit 700 is not limited to the above-mentioned location, and may be located in a desirable location for measuring concentration of carbon dioxide inside the oxygen cap 200.

In an embodiment, the respiratory sensor unit 700 may include a respiratory sensor module 710 that detects the respiration of the companion animal 1 at preset time intervals.

The communication unit 800 may be implemented through at least one of a wireless Internet module and a short-range communication module. The wireless Internet module refers to a module for wireless Internet access and may be built into or external to each device. Wireless Internet technologies such as WLAN (Wireless LAN) (Wi-Fi), Wibro (Wireless broadband), Wimax (World Interoperability for Microwave Access), HSDPA (High Speed Downlink Packet Access), LTE (long term evolution), and LTE-A (Long Term Evolution-Advanced) may be used.

The controller 900 may receive carbon dioxide concentration information emitted through the respiration of the companion animal 1 and present inside the oxygen cap 200 from the respiratory sensor unit 700, and the controller 900 may analyze respiratory pattern information of the companion animal 1 through the carbon dioxide concentration information.

The respiratory pattern information includes information that may distinguish between normal and rapid respiration of the companion animal 1 based on the carbon dioxide concentration information.

The controller 900 may generate closing information of the respiratory tube valve 310 based on the carbon dioxide concentration information and the respiratory pattern information.

The closing information may determine when the companion animal 1 needs more oxygen supply and inform whether the respiratory tube valve 310 is opened.

Information that the controller 900 may analyze through the respiratory sensor unit 700 is not limited to the carbon dioxide concentration information and the respiratory pattern information described above.

The controller 900 transmits the above-described closing information to the user terminal 600 through the communication unit 800 that is connected to be able to conduct electricity. As a result, the user may check whether the companion animal 1 currently needs more oxygen through the user terminal 600, and thus may check information on whether the respiratory tube valve 310 is open.

Although embodiments of the present disclosure have been described with reference to the attached drawings, those skilled in the art to which the present disclosure pertains will understand that various modifications and changes may be made to the present disclosure without departing from the technical spirit and technical scope of the present disclosure as set forth in the claims to be described later. Therefore, the embodiments described above should be understood in all respects as illustrative and not restrictive.

1. A neck collar for companion animals capable of supplying oxygen, comprising:
a neck mounting part provided with a through hole in which a neck of a companion animal is positioned when worn by the companion animal;
an oxygen cap coupled to the neck mounting part and forming a predetermined space to accommodate a head of the companion animal; and
a respiratory tube with one end passing through one side surface of the oxygen cap and connected to the oxygen cap, so as to supply oxygen inside the oxygen cap.

2. The neck collar of claim 1, wherein the respiratory tube comprises a respiratory tube valve located at one end of the respiratory tube to be coupled to the respiratory tube, so as to control an amount of oxygen supplied to the oxygen cap.

3. The neck collar of claim 1, wherein the oxygen cap comprises a respiratory tube with one end passing through one side surface of the oxygen cap and connected to the oxygen cap, so as to supply oxygen inside the oxygen cap.

4. The neck collar of claim 1, wherein the neck mounting part comprises:
an air tube capable of being compressed and expanded by inflow and outflow of air; and
an air supply tube connected to allow communication between the air tube and an outside, so as to allow air to flow into and out of the air tube.

5. The neck collar of claim 4, wherein the air tube comprises an elastic body configured to be stored in a compressed state inside the air tube and expand when the air supply tube is opened so that air automatically flows into the air tube.

6. The neck collar of claim 5, wherein the air tube comprises a first air tube and a second air tube configured to be separated and coupled based on a plane of symmetry, and
the air supply tube comprises:
a first air supply tube located on the first air tube and configured to allow communication of air between the first air tube and the outside; and
a second air supply tube located on the second air tube and configured to allow communication of air between the second air tube and the outside.

7. The neck collar of claim 1, wherein the neck mounting part is formed so that a side surface is bent, to allow the companion animal to lean its head when sitting or lying down.

8. The neck collar of claim 1, wherein the through hole comprises:
an elastic member formed surrounding an inner surface of the through hole, so as be coupled to the neck of the companion animal by being stretched to fit a neck circumference of the companion animal; and
a locking part configured to lock-couple the elastic member to fit a neck size of the companion animal.

9. The neck collar of claim 1, wherein the oxygen cap is configured so that a lower side of the oxygen cap is zipper-coupled with an outer side surface of the neck mounting part.

10. A neck collar for companion animals capable of supplying oxygen, comprising:
a neck mounting part provided with a through hole in which a neck of a companion animal is positioned when worn by the companion animal;
an oxygen cap coupled to the neck mounting part and forming a predetermined space to accommodate a head of the companion animal; and
a filter part whose upper side is coupled to the oxygen cap and whose lower side is coupled to the neck mounting part.

11. The neck collar of claim 11, wherein the neck collar comprises a respiratory tube with one end passing through one side surface of the oxygen cap and connected to the oxygen cap, so as to supply oxygen inside the oxygen cap.

12. The neck collar of claim 11, wherein the respiratory tube comprises a respiratory tube valve located at one end of the respiratory tube to be coupled to the respiratory tube, so as to control an amount of oxygen supplied to the oxygen cap.

13. The neck collar of claim 10, wherein the upper side of the filter part is zipper-coupled with a lower side of the oxygen cap and the lower side of the filter part is zipper-coupled with an upper side of the neck mounting part, so that the filter part is capable of being separated and coupled.

14. The neck collar of claim 10, wherein the filter part comprises a bellows filter capable of contracting and expanding along a height direction.

15. The neck collar of claim 10, wherein the neck mounting part comprises:
an air tube capable of being compressed and expanded by inflow and outflow of air; and
an air supply tube connected to allow communication between the air tube and an outside, so as to allow air to flow into and out of the air tube.

16. The neck collar of claim 15, wherein the air tube comprises an elastic body configured to be stored in a compressed state inside the air tube and expand when the air supply tube is opened so that air automatically flows into the air tube.

17. An oxygen supply system through a neck collar for companion animals, the oxygen supply system comprising:
a neck mounting part provided with a through hole in which a neck of a companion animal is positioned when worn by the companion animal;
an oxygen cap coupled to the neck mounting part and forming a predetermined space to accommodate a head of the companion animal;
a respiratory tube with one end passing through one side surface of the oxygen cap and connected to the oxygen cap, so as to supply oxygen inside the oxygen cap;
a filter part whose upper side is coupled to the oxygen cap and whose lower side is coupled to the neck mounting part;
a user terminal capable of communication;
a respiratory sensor unit configured to detect information on respiration of the companion animal accommodated in the oxygen cap;
a controller configured to receive and analyze information of the respiratory sensor unit; and
a communication unit connected to the user terminal, the respiratory sensor unit, and the controller to be able to conduct electricity,
wherein the controller is configured to:
receive concentration information of carbon dioxide emitted through the respiration of the companion animal and present inside the oxygen cap from the respiratory sensor unit;
analyze respiratory pattern information of the companion animal through the carbon dioxide concentration information; and
generate closing information of a respiratory tube valve based on the carbon dioxide concentration information and the respiratory pattern information.
